(19) United States
(12) Patent Application Publication
(10) Pub. No.: US 2005/0087680 A1
(43) Pub. Date: Apr. 28, 2005

(54) Light source for optical encoder

(76) Inventor: Shu-Feng Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/689,652

(22) Filed: Oct. 22, 2003

(51) Int. Cl. G01D 5/34

(52) U.S. Cl. 250/231.13; 250/231.14

(57) ABSTRACT

A light source is provided for an optical encoder. The optical encoder has an optical detector with a plurality of light receiving surfaces and an encoder wheel intermittently blocking a light from the light source. The light source comprises at least one light-emitting diode, a package casing; and a collimating unit with lenses corresponding to the light receiving surfaces. The collimating unit is one-piece formed with package casing or assembled to the package casing. The lenses are plane-convex lenses or double-convex lenses to overcome proximal interference.

### FIELD OF THE INVENTION

The present invention relates to a light source of an optical encoder, especially to a light source of an optical encoder to overcome proximal interference.

### BACKGROUND OF THE INVENTION

With improvements of computer software and universal graphical user interface, mice in computer user interface are used widely. The prior art mouse such as mechanical mouse controls the cursor on the computer screen by a rolling ball and an optical encoder. Refer to FIG. 1, it is a top view of a mechanical mouse 10. The mechanical mouse 10 mainly comprises a rolling ball 100, at least one rolling axis 102, and a corresponding optical encoder 110. The optical encoder 110 comprises an encoder wheel 112 linked with the rolling axis 102, and an optical module 114 on both sides of the encoder wheel 112. The optical module 114 comprises a light source 114A and an optical detector 114B. The encoder wheel 112 is rotated along x- and y-direction when the rolling ball 100 is rotated. The light signals of the light source 114A are blocked intermittently by the encoder wheel 112 and received by the optical detector 114B. Therefore, the displacement of the mouse is read, and the directions of the cursor on the computer screen can be controlled via a driving program of computers.

FIG. 2 is a sectional view of an optical encoder 110. The optical detector 114B mainly has two light receiving surfaces (no label, shown as shaded region), and the light receiving surfaces receive the light blocked intermittently by the encoder wheel 112 to identify the directions and the displacement of the ball. The optical encoder 110 in FIG. 2 decides the rotation of the encoder wheel 112 by the fact that whether the light signals is received by the light receiving surfaces of the encoder wheel 112. However, due to the diffraction of the light, the light emitted by the light source 114A is not easily identified for its divergence. FIG. 3 depicts the sectional view of the other prior art optical encoder 110, and there are also two light receiving surfaces (no label, shown as shaded region) on the optical detector 114B of the optical encoder 110. The optical encoder 110 has an encoder wheel 113 with an array of lenses to overcome the phenomenon of diffraction, and the rotation of the encoder wheel 113 can be decided more precisely by the light focused by the lenses. Therefore, the directions and the displacement of the rolling ball 100 can be decided more precisely.

However, the problem of proximal interference still exists when using the two known optical encoders 110. Because of the phenomenon of light interference, high-intensity light is produced between the two light receiving surfaces. More particularly, when two light beams are projected to the two light receiving surfaces, respectively, a high-intensity light is produced between the two light receiving surfaces due to constructive interference. FIG. 4 shows the detection result influenced by the proximal interference. The solid line shows ideal detection result and dashed line shows a realistic detection result influenced by the proximal interference, wherein the signal is excessive at trough.

FIG. 5 depicts the sectional view of another prior art optical encoder 110. In order to solve the mentioned problem, a mask 116 is provided in front of the optical detector 114B to block the part between the two light receiving surfaces. Because of the wave nature of the light, the problem of proximal interference still cannot be solved effectively.

### SUMMARY OF THE INVENTION

The objective of the present invention is to provide a light source of an optical encoder to overcome proximal interference.

To achieve the mentioned purpose, the present invention provides a light source of an optical encoder to alleviate the proximal interference. The optical encoder comprises an optical detector with light receiving surfaces thereon, and an encoder wheel, which shelters the light of the light source intermittently. The light source comprises at least one light-emitting diode, a package casing; and a collimating unit with lenses corresponding to the light receiving surfaces. The collimating unit is in one-piece formed with package casing or assembled to the package casing. The lenses are plane-convex lenses or double-convex lenses to overcome proximal interference. The collimating unit also can be implemented by openings corresponding to the light receiving surfaces to solve the problem of proximal interference.

The various objects and advantages of the present invention will be more readily understood from the following detailed description when read in conjunction with the appended drawing, in which:

### BRIEF DESCRIPTION OF DRAWING

FIG. 1 shows a top view of a prior art mechanical mouse;

FIG. 2 shows a sectional view of a prior art optical encoder;

FIG. 3 shows a sectional view of another prior art optical encoder;

FIG. 4 explains the influence on the signals detecting by proximal interference;

FIG. 5 shows a sectional view of still another prior art optical encoder;

FIG. 6A and FIG. 6B depict a schematic view of a preferred embodiment of the present invention;

FIG. 7A and FIG. 7B depict a schematic view of another preferred embodiment of the present invention;

FIG. 8A and FIG. 8B depict a schematic view of still another preferred embodiment of the present invention.

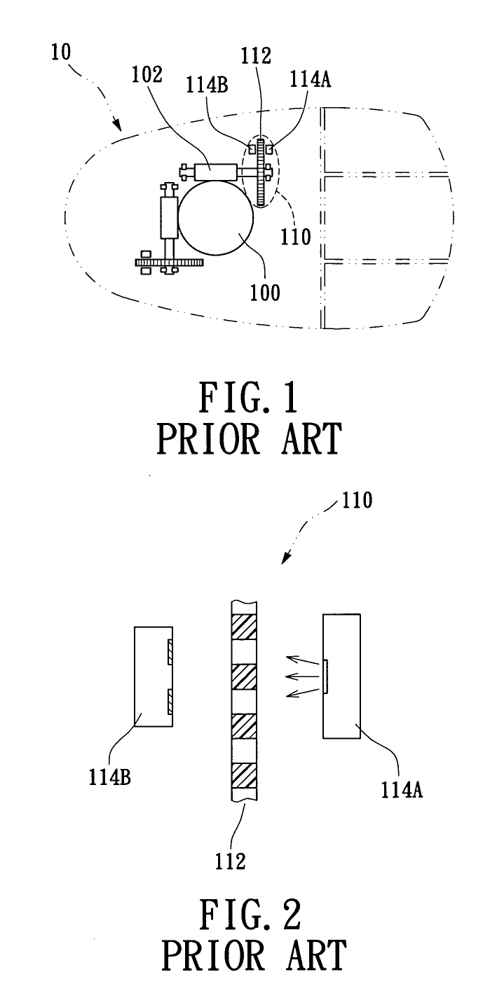

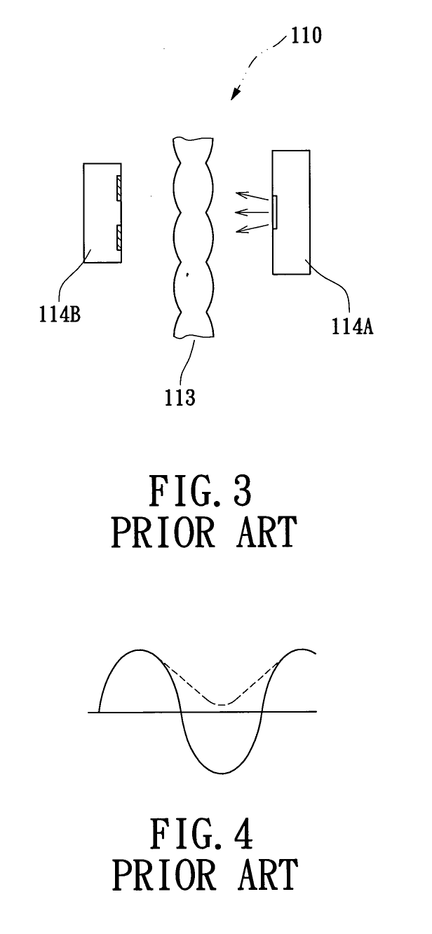

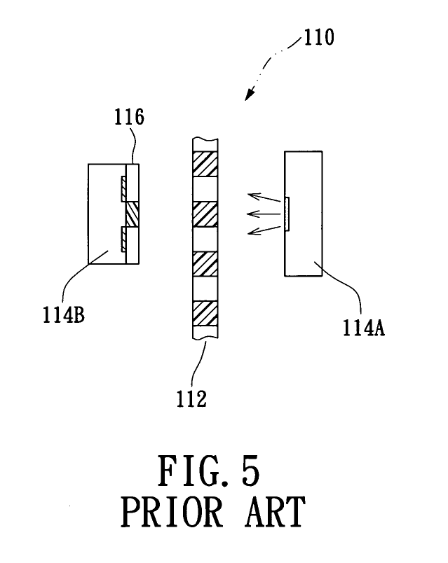

### DETAILED DESCRIPTION OF THE INVENTION

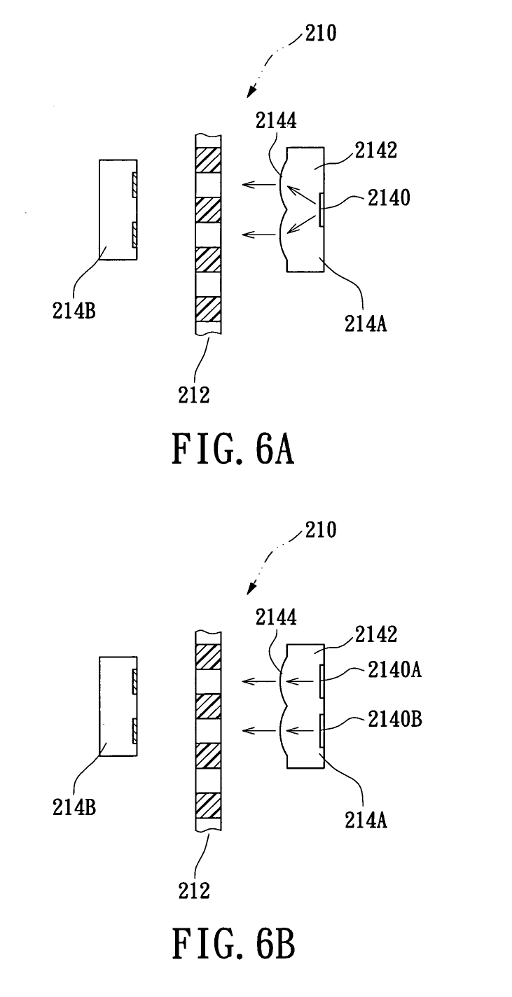

FIG. 6 shows schematic view of light source of an optical encoder according to the first preferred embodiment of the present invention. The optical encoder 210 of the present invention also comprises a light source 214A, an optical detector 214B with two light receiving surfaces (no label, shown as shaded region), and an encoder wheel 212 blocking the light emitted from the light source 214A intermittently. The optical detector 214B and the encoder wheel 212 are not described in detail for both two components are prior arts.

As FIG. 6 shows, the light source 214A comprises a light-emitting diode 2140 and a package casing 2142. The package casing 2142 comprises a light-collimating unit 2144 one-piece formed with the package casing 2142 and corresponding to the light receiving surfaces of the optical detector 214B. The light-collimating unit 2144 comprises two plane-convex lenses or two double-convex lenses to focus the beam of light to the light receiving surfaces on the optical detector 214B. In the first preferred embodiment of the invention, the number of lenses in the light-collimating unit 2144 should correspond to the number of the light receiving surfaces and is not restricted to be two. The lenses of the light-collimating unit 2144 are set on the position that the light emitted by light-emitting diode 2140 can be focused to the light receiving surfaces of the optical detector 214B.

In the mentioned preferred embodiment of the present invention, the number of light-emitting diodes is also not restricted to be one and can correspond to the number of the light receiving surfaces. As FIG. 6B shows, if two light receiving surfaces are provided to optical detector 214B, there are also two light-emitting diodes 2140A and 2140B in the light source 214A. The provision of the corresponding light-collimating unit 2144 can focus the light of the light source 214A more precisely.

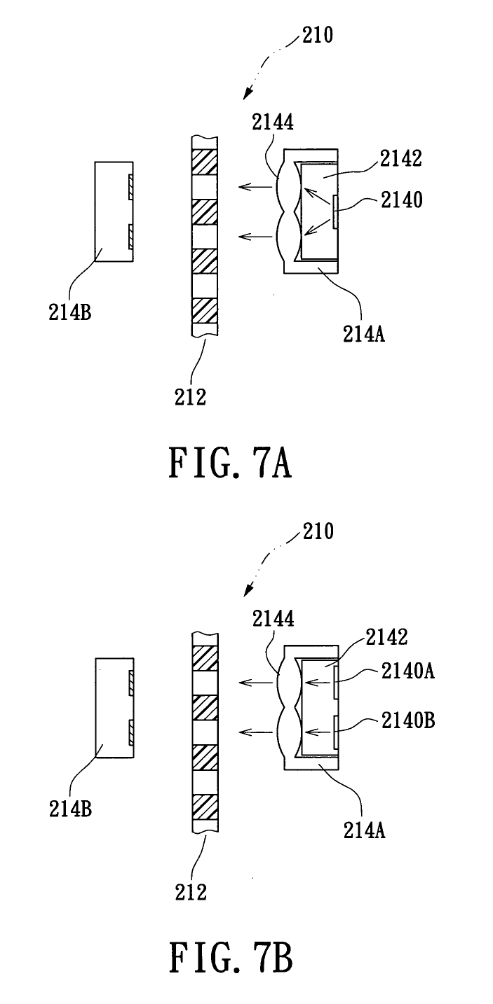

FIG. 7A shows schematic view of light source of an optical encoder according to the second preferred embodiment of the present invention. As FIG. 7A shows, the light source 214A comprises a light-emitting diode 2140 and a package casing 2142. The package casing 2142 comprises a light-collimating unit 2144 assembled to the package casing 2142 and corresponding to the light receiving surfaces of the optical detector 214B. The light-collimating unit 2144 comprises two plane-convex lenses or two double-convex lenses to focus the beam of light to the light receiving surfaces on the optical detector 214B. In the second preferred embodiment of the invention, the number of lenses in the light-collimating unit 2144 should correspond to the number of the light receiving surfaces and is not restricted to be two. The lenses of the light-collimating unit 2144 are set on the position that the light emitted by light-emitting diode 2140 can be focused to the light receiving surfaces of the optical detector 214B.

In the mentioned preferred embodiment of the present invention, the number of light-emitting diodes is also not restricted to be one and can correspond to the number of the light receiving surfaces. As FIG. 7B shows, if two light receiving surfaces are provided to optical detector 214B, there are also two light-emitting diodes 2140A and 2140B in the light source 214A. The provision of the corresponding light-collimating unit 2144 can focus the light of the light source 214A more precisely.

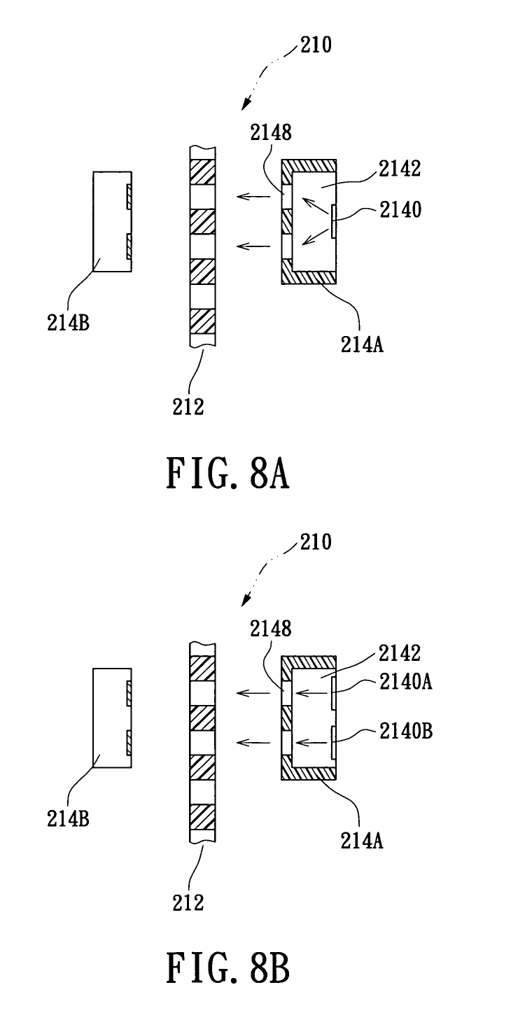

FIG. 8A shows a schematic view of light source structure improvement of an optical encoder according to the third preferred embodiment of the present invention. As FIG. 8A shows, the light source 214A comprises a light-emitting diode 2140 and a package casing 2142. The package casing 2142 comprises a pair of openings 2148. The light of the light-emitting diode 2140 can be split by the openings 2148 and aligned with the light receiving surfaces of the optical detector 214B. In the third preferred embodiment of the present invention, the number of the openings is not restricted to be two and should correspond to the number of the light receiving surfaces. The openings are provided on the position that the light emitted by light-emitting diode 2140 can be guided at the light receiving surfaces of the optical detector 214B.

In the mentioned preferred embodiment of the present invention, the number of light-emitting diodes is also not restricted to be one and can correspond to the number of the light receiving surfaces. As FIG. 8B shows, if two light receiving surfaces are provided to optical detector 214B, there are also two light-emitting diodes 2140A and 2140B in the light source 214A. The provision of the corresponding light-collimating unit 2144 can focus the light of the light source 214A more precisely.

Although the present invention has been described with reference to the preferred embodiment therefore, it will be understood that the invention is not limited to the details thereof. Various substitutions and modification s have suggested in the foregoing description, and other will occur to those of ordinary skill in the art. For example, the light source can be a light with better coherence such as laser light. The number of the light receiving surfaces can be three or more and the lens and the light-emitting diodes also have corresponding number. Therefore, all such substitutions and modifications are intended to be embrace within the scope of the invention as defined in the appended claims.

1. A light source of an optical encoder, the optical encoder having an optical detector with a plurality of light receiving surfaces and an encoder wheel intermittently blocking a light from the light source, the light source comprising:
at least one light-emitting diode;
a package casing; and
a collimating unit with lenses corresponding to the light receiving surfaces.

2. The light source of an optical encoder as in claim 1, wherein the collimating unit is one-piece formed formed with package casing.

3. The light source of an optical encoder as in claim 2, wherein the lenses are plane-convex lenses.

4. The light source of an optical encoder as in claim 2, wherein the lenses are double-convex lenses.

5. The light source of an optical encoder as in claim 1, wherein the collimating unit is assembled on the package casing.

6. The light source of an optical encoder as in claim 5, wherein the lenses are plane-convex lenses.

7. The light source of an optical encoder as in claim 5, wherein the lenses are double-convex lenses.

8. The light source of an optical encoder as in claim 1, wherein the number of light-emitting diodes corresponds to the number of the light receiving surfaces.

9. A light source of an optical encoder, the optical encoder having an optical detector with a plurality of light receiving surfaces and an encoder wheel intermittently blocking a light from the light source, the light source comprising:
at least one light-emitting diode;
a package casing; and
a collimating unit with openings corresponding to the light receiving surfaces.

10. The light source of an optical encoder as in claim 9, wherein the collimating unit is one-piece formed formed with package casing.

11. The light source of an optical encoder as in claim 9, wherein the collimating unit is assembled on the package casing.

12. The light source of an optical encoder as in claim 9, wherein the number of light-emitting diodes corresponds to the number of the light receiving surfaces.
